(19) United States
(12) Patent Application Publication
(10) Pub. No.: US 2026/0228846 A1
(43) Pub. Date: Aug. 6, 2026

(54) EVACUATION PLAN CALCULATION APPARATUS, EVACUATION PLAN CALCULATION METHOD AND PROGRAM

(71) Applicant: NTT, Inc., Tokyo (JP)

(72) Inventors: Hitoshi SHIMIZU, Tokyo (JP); Tomoharu IWATA, Tokyo (JP); Akinori FUJINO, Tokyo (JP); Hiroshi SAWADA, Tokyo (JP)

(21) Appl. No.: 19/147,850

(22) PCT Filed: Jan. 18, 2023
(86) PCT No.: PCT/JP2023/001352

§ 371 Date: Jul. 14, 2025

(51) Int. Cl. G06Q 50/26; G06Q 90/00

(52) U.S. Cl. CPC G06Q 50/265; G06Q 90/205

(57) ABSTRACT

An evacuation plan calculation apparatus includes an evacuation plan calculation unit configured to calculate an evacuation plan chronologically indicating the number of residents staying at home during a predetermined period by solving a linear planning problem to minimize a home residence cost that is a cost of disaster victims staying at the home under a constraint of a capacity of a shelter during the predetermined period based on data chronologically indicating a home residence cost which is a cost per person a disaster victim of a certain disaster staying at home. The evacuation plan calculation apparatus thereby improves applicability of support of evacuation.

### TECHNICAL FIELD

The present invention relates to an evacuation plan calculation apparatus, an evacuation plan calculation method, and a program.

### BACKGROUND ART

A technique for evaluating a timing of evacuation in consideration of a cost of evacuation and a cost of disaster damage when an evacuation instruction during occurrence of a disaster is determined has been examined (Non-Patent Literature 1).

In order to prevent disaster victims from being moved around a plurality of times when shelters are overcrowded, a technique for indicating a shelter to which a disaster victim who has arrived at a shelter should move has been examined (Non-Patent Literature 2).

### CITATION LIST

### Non-Patent Literature

Non-Patent Literature 1: Jeffrey Czajkowski, “Is It Time to Go Yet? Understanding Household Hurricane Evacuation Decisions from a Dynamic Perspective”, NATURAL HAZARDS REVIEW, Vol. 12, No. 2, ASCE/May 2011/1
Non-Patent Literature 2: Shimizu, Iwata, Suwa, Yasumoto, “Evacuation Guidance between Shelters Using Minimal Cost Flow”, the Institute of Electronics, Information and Communication Engineers, Journal of Society of Japan, D Vol. J105-D No. 3, pp. 175 to 185, and the Institute of Electronics, Information and Communication Engineers 2022

### SUMMARY OF INVENTION

### Technical Problem

In techniques of the related art, since it is assumed that all disaster victims can be accommodated in shelters, it is difficult to apply the techniques to a case where the number of disaster victims exceed the capacity of shelters.

The present invention has been devised in view of the foregoing circumstances, and an object of the present invention is to improve applicability of support of evacuation.

### Solution to Problem

To solve the above problem, an evacuation plan calculation apparatus includes an evacuation plan calculation unit configured to calculate an evacuation plan chronologically indicating the number of residents staying at home during a predetermined period by solving a linear planning problem to minimize a home residence cost that is a cost of disaster victims staying at the home under a constraint of a capacity of a shelter during the predetermined period based on data chronologically indicating a home residence cost which is a cost per person a disaster victim of a certain disaster staying at home.

### Advantageous Effects of Invention

It is possible to improve applicability of support of evacuation.

### BRIEF DESCRIPTION OF DRAWINGS

FIG. 1 is a diagram illustrating an example of a hardware configuration of an evacuation plan calculation apparatus 10 according to a first embodiment.

FIG. 2 is a diagram illustrating an example of a functional configuration of the evacuation plan calculation apparatus 10 according to the first embodiment.

FIG. 3 is a flowchart illustrating an example of a processing procedure executed by the evacuation plan calculation apparatus 10.

FIG. 4 is a diagram illustrating an example of a configuration of a shelter DB 121.

FIG. 5 is a diagram illustrating an example of a configuration of a residence cost DB 122.

FIG. 6 is a diagram illustrating an example of a configuration of a movement cost DB 123.

FIG. 7 is a diagram illustrating an example of a number-of-shelter resident people plan.

FIG. 8 is a diagram illustrating an example of a shelter management plan.

FIG. 9 is a diagram illustrating an example of a number-of-moving people plan.

### DESCRIPTION OF EMBODIMENTS

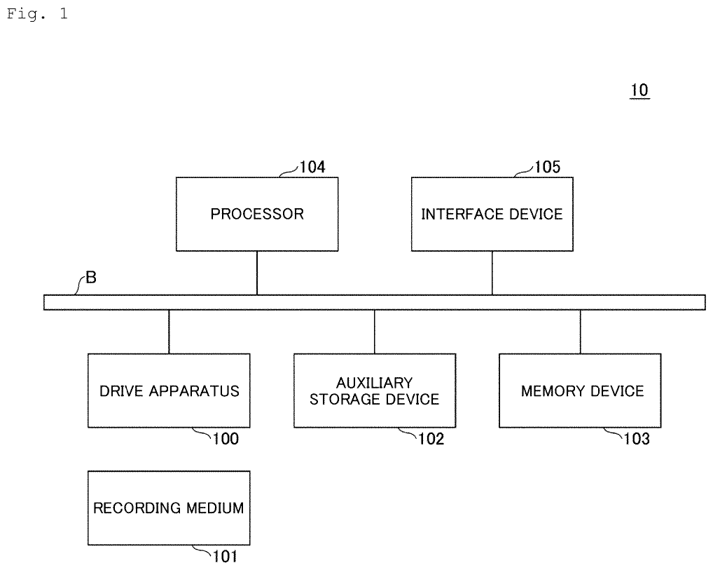

Hereinafter, embodiments of the present invention will be described with reference to the drawings. FIG. 1 is a diagram illustrating an example of a hardware configuration of an evacuation plan calculation apparatus 10 according to a first embodiment. The evacuation plan calculation apparatus 10 in FIG. 1 includes a drive device 100, an auxiliary storage device 102, a memory device 103, a processor 104, and an interface device 105 that are connected to each other by a bus B.

A program that realizes processing in the evacuation plan calculation apparatus 10 is provided by a recording medium 101 such as a CD-ROM. When the recording medium 101 that stores the program is set in the drive device 100, the program is installed from the recording medium 101 to the auxiliary storage device 102 via the drive device 100. However, the program does not necessarily have to be installed from the recording medium 101 and may be downloaded from another computer via a network. The auxiliary storage device 102 stores the installed program as well as required files, data, and the like.

The memory device 103 reads and stores the program from the auxiliary storage device 102 when an instruction to start the program is given. The processor 104 is a CPU or a graphics processing unit (GPU), or a CPU and a GPU and executes a function related to the evacuation plan calculation apparatus 10 in accordance with the program stored in the memory device 103. The interface device 105 is used as an interface for connection to the network.

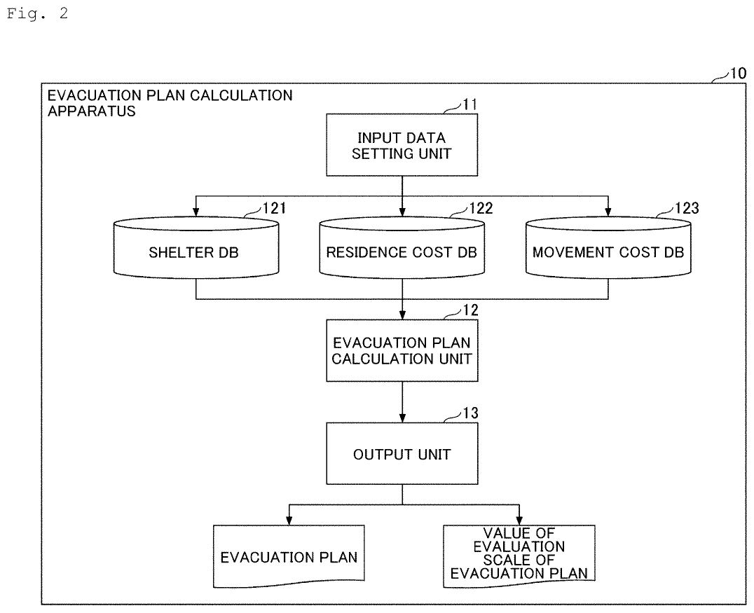

FIG. 2 is a diagram illustrating an example of a functional configuration of the evacuation plan calculation apparatus 10 according to the first embodiment. In FIG. 2, the evacuation plan calculation apparatus 10 includes an input data setting unit 11, an evacuation plan calculation unit 12, and an output unit 13. Each of these units is realized through processing for causing the processor 104 to execute one or more programs installed in the evacuation plan calculation apparatus 10. The evacuation plan calculation apparatus 10 also uses a database (storage unit) such as a shelter DB 121, a residence cost DB 122, and a movement cost DB 123. These storage units can be realized using, for example, the auxiliary storage device 102, a storage device that can be connected to the evacuation plan calculation apparatus 10 via the network, or the like.

The evacuation plan calculation apparatus 10 calculates (generates) an evacuation plan for residents (disaster victims) regarding a certain disaster in a certain area based on the functional configuration.

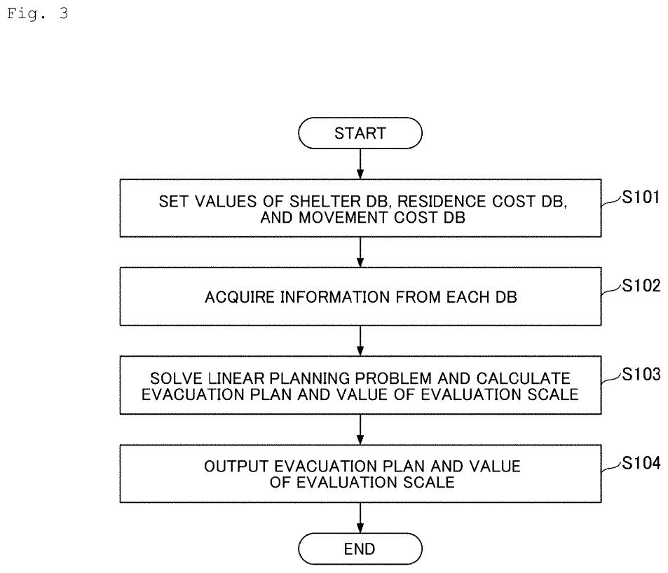

Hereinafter, a processing procedure executed by the evacuation plan calculation apparatus 10 will be described. FIG. 3 is a flowchart illustrating an example of a processing procedure executed by the evacuation plan calculation apparatus 10.

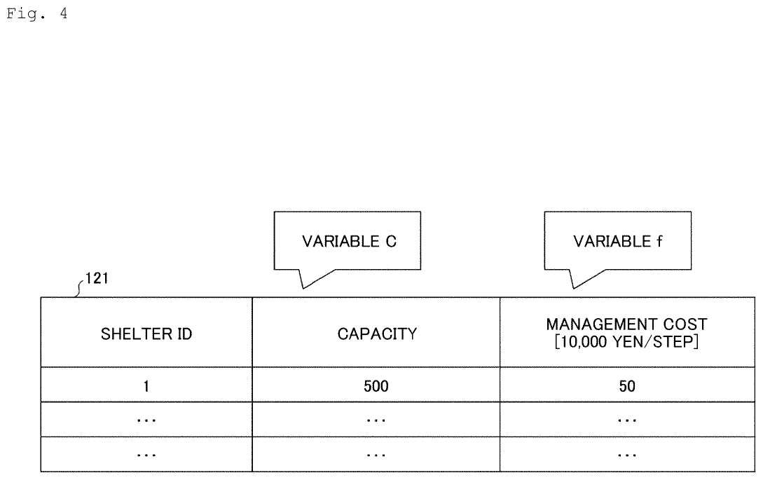

In step S101, the input data setting unit 11 sets values of the shelter DB 121, the residence cost DB 122, and the movement cost DB 123 based on a damage situation estimated for a predicted disaster. The predicted disaster may be a disaster of which occurrence is actually imminent, a disaster of which occurrence is predicted in future, or other disasters. The damage situation estimated about the predicted disaster is a geographical damage situation estimated based on a place, a scale, and the like of the predicted disaster. For example, in the case of a flood disaster, a water level or the like may be simulated according to each of areas by applying the location of occurrence, the scale, and the like of a predicted disaster to a hazard map or the like. Alternatively, the damage situation may be estimated using the following Web sites.
(1) https://gbank.gsj.jp/seamless/shinsui/
(2) https://suiboumap.gsi.go.jp/
(3) https://www.suigaitaisaku.com/2019/06/27/shinsuishin/
   FIG. 4 is a diagram illustrating an example of a configuration of the shelter DB 121. As illustrated in FIG. 4, a shelter ID, a capacity, and a management cost are set for each shelter in the shelter DB 121. The shelter ID is identification information of a shelter. The capacity is an upper limit of the number of people that can be accommodated in the shelter. The management cost is a cost (an amount of money) incurred for management per step regardless of the number of accommodated people. The step is a time interval (unit time) where a predetermined period for which the evacuation plan calculation apparatus 10 in the embodiment generates an evacuation plan is divided into a plurality of such time interval. One step is, for example, one day. However, one step may not be one day. The step may be appropriately determined according to granularity of a time at which the evacuation plan is to be generated, and may be, for example, one hour or one week. Lengths of respective steps may not be constant.

In the shelter DB 121, the shelter ID and the capacity may be constant regardless of a geographical damage situation. The management cost includes not only an economic cost required for the management of the shelter but also a cost (risk) of human damage such as to a staff member who manages the shelter. The cost of such human damage (human damage amount) may differ depending on the geographical damage situation due to the disaster. For example, the cost (risk) of human damage such as staff differs between a shelter located in an area that has flooded and a shelter not located in an area that has not flooded. Accordingly, the management cost may be set based on the geographical damage situation due to the disaster. However, the management cost may also be a fixed value. The cost of human damage (human damage amount) includes, for example, a property damage amount and a mental damage amount. The property damage amount includes, for example, a lost profit (future profit considered to have been obtained if there were no damage) and a medical expense. In FIG. 4, a variable corresponding to each item is shown in a balloon as will be described below.

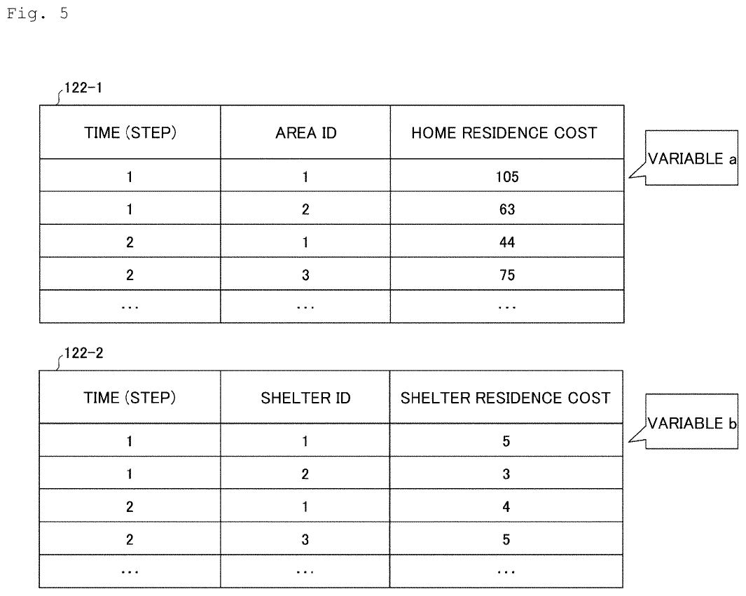

FIG. 5 is a diagram illustrating an example of a configuration of the residence cost DB 122. As illustrated in FIG. 5, the residence cost DB 122 includes a home residence cost table 122-1 and a shelter residence cost table 122-2.

Data chronologically indicating a cost per person who is a disaster victim staying at home is set at the home residence cost table 122-1. In the example of FIG. 5, the home residence cost at each time (step) is set at the home residence cost table 122-1 for each area ID. The area ID is identification information of the area. Units of areas may be set in advance. The area may be a geographical range including a plurality of addresses or may be for each address. The home residence cost is a magnitude of human damage per person caused due to residence at home in an area associated with the area ID.

Data chronologically indicating a cost per person who is a disaster victim staying in each shelter is set in the shelter residence cost table 122-2. In the example in FIG. 5, a shelter residence cost at each time (step) is set in the shelter residence cost table 122-2 for each shelter ID. The shelter ID has been described above. The shelter residence cost is a magnitude of a human damage per person caused due to residence in the shelter.

The home residence cost or the shelter residence cost is set in each step for each area ID or each shelter ID because a geographical damage situation may differ chronologically for each area or each shelter. Accordingly, the chronological home residence cost or shelter residence cost of each area ID or each shelter ID may be set based on data chronologically indicating a geographical damage situation due to a disaster. In FIG. 5, as will be described below, a variable corresponding to the home residence cost or the shelter residence cost is shown in a balloon. In the following description, if the home residence cost and the shelter residence cost are not distinguished from each other, the residence costs are referred to as “residence costs”.

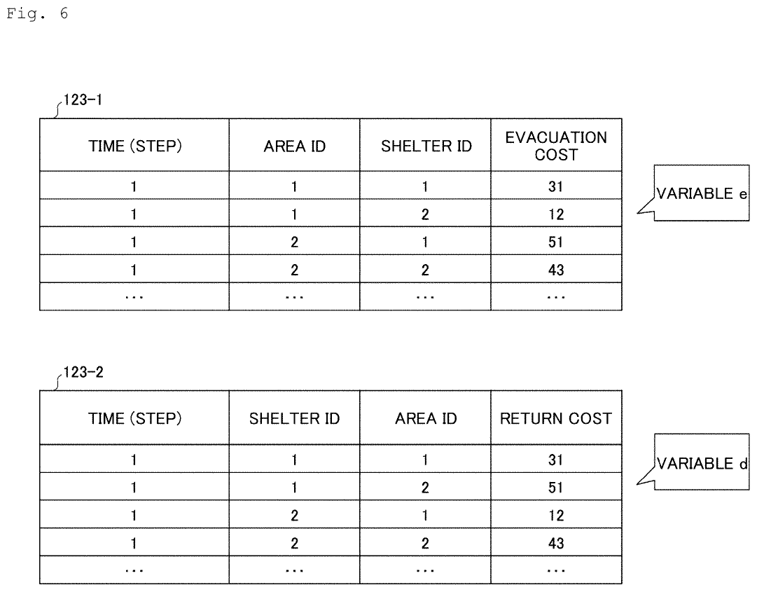

FIG. 6 is a diagram illustrating an example of a configuration of the movement cost DB 123. As illustrated in FIG. 6, the movement cost DB 123 includes an evacuation cost table 123-1 and a return cost table 123-2.

In the evacuation cost table 123-1, data chronologically indicating a cost per person who is a disaster victim moving from the home to each shelter is set. In the example illustrated in FIG. 6, an evacuation cost in each step (time) is set in the evacuation cost table 123-1 for each set of the area ID and the shelter ID. The evacuation cost is a cost per person when the disaster victim moves (evacuates) from an area (home located in the area) related to the area ID to a shelter related to the shelter ID. The cost may be a magnitude of a human damage or a value proportional to a distance between an area (home located in the area) related to the area ID and a shelter related to the shelter ID.

Data chronologically indicating a cost per person who is a disaster victim moving from each shelter to the home is set in the return cost table 123-2. In the example illustrated in FIG. 6, the return cost at each step (time) is set in the return cost table 123-2 for each set of the shelter ID and the area ID. The return cost is a cost per person when the disaster victim moves (returns) from the shelter related to the shelter ID to an area (a home located in the area) related to the area ID. The cost may be a magnitude of a human damage or a value proportional to a distance between the shelter related to the shelter ID and an area (a home located in the area) related to the area ID.

The evacuation cost or the return cost is set in each step for each set of the area ID and the shelter ID because a geographical damage situation may differ chronologically for each route from the home to the shelter or each route from the shelter to the home. Accordingly, the chronological evacuation cost or return cost of each set of the area ID and the shelter ID may be set based on data chronologically indicating the geographical damage situation due to the disaster.

In FIG. 6, in the evacuation cost tables 123-1 and 123-1, the evacuation cost and the return cost in the same step for the same set of the area ID and the shelter ID are set to the same value. This is based on the idea that the magnitude of the human damage is the same if the routes of the going path and the returning path are the same. However, when a burden of movement is different between the going path and the returning path, for example, the going path is a downhill and the returning path is an uphill, the evacuation cost and the return cost for the same route in the same step (time) may be different. In the embodiment, the evacuation cost table 123-1 and the return cost table 123-2 are divided in consideration of such a situation. In FIG. 6, a variable corresponding to the evacuation cost or the return cost is described in a balloon, as will be described below. If the evacuation cost and the return cost are not distinguished from each other in the following description, the costs are referred to as “movement costs”.

In the above, the magnitude of the human damage per person may be, for example, “mortality rate×human damage amount of one person” or may be another index. Estimation and digitization of the magnitude of the human damage based on a geographical damage situation may be performed using a known technique. Alternatively, the shelter DB 121, the residence cost DB 122, and the movement cost DB 123 are generated in advance according to a scale of the disaster. In step S101, the shelter DB 121, the residence cost DB 122, and the movement cost DB 123 corresponding to the scale of a current disaster may be selected.

Subsequently, the evacuation plan calculation unit 12 acquires information stored in the shelter DB 121 (FIG. 4), the residence cost DB 122 (FIG. 5), and the movement cost DB 123 (FIG. 6) (S102).

Subsequently, the evacuation plan calculation unit 12 calculates (generates) an evacuation plan for each step and a value of the evaluation scale of the evacuation plan during a predetermined period T by applying the information acquired in step S102 to a linear planning problem in which the minimization of a sum of the movement cost and the residence cost of each disaster victim during the period T and the management cost of the shelter during the period T is formulated as an objective function and solving the linear planning problem (S103).

Hereinafter, the objective function of the linear planning problem will be described below.

$$[ Math . 1 ]$$

$${{\sum }^{T}}_{t = 1} [ {\sum }_{n ∈ N} {\sum }_{m ∈ M} ( {e}_{t}^{n \to m} {v}_{t}^{n \to m} + {d}_{t}^{m \to n} {z}_{t}^{m \to n} ) + {\sum }_{n ∈ N} {a}_{t}^{n} {s}_{t}^{n} + {\sum }_{n ∈ N} {\sum }_{m ∈ M} {b}_{t}^{m} {x}_{t}^{n \to m} + {\sum }_{m ∈ M} {f}_{t}^{m} {y}_{t}^{m} ] \qquad ( 1 )$$

Constraint conditions of the linear planning problem will be described below.

$$[ Math . 2 ]$$

$${\sum }_{n ∈ N} {x}_{t}^{n \to m} \leq {C}_{m} {y}_{t}^{m} \qquad ( 2 )$$

$${s}_{t + 1}^{n} - {s}_{t}^{n} = {\sum }_{m ∈ M} ( {z}_{t}^{m \to n} - {v}_{t}^{n \to m} ) \qquad ( 3 )$$

$${x}_{t + 1}^{n \to m} - {x}_{t}^{n \to m} = {v}_{t}^{n \to m} - {z}_{t}^{m \to n} \qquad ( 4 )$$

$${s}_{t}^{n} , {x}_{t}^{n \to m} , {v}_{t}^{n \to m} , {z}_{t}^{m \to n} ∈ {Z}_{\geq 0} \qquad ( 5 )$$

$${y}_{t}^{m} ∈ \{ 0 , 1 \} \qquad ( 6 )$$

$${s}_{t}^{n} = 0 \qquad ( 7 )$$

$${y}_{t = 0}^{m} = 0 \qquad ( 8 )$$

$${x}_{t = 0}^{n \to m} = 0 \qquad ( 9 )$$

Here, the meaning of each sign (variable) is as follows.
N: a set of area IDs: nϵN (hereinafter, an area with an area ID=n is referred to as an “area n”.)
M: a set of shelter IDs: mϵM (hereinafter, a shelter with shelter ID=m is referred to as a “shelter m”.)
T: a set of steps in which a cost is considered:
tϵT (hereinafter, a t-th step is referred to as a step t.)
aₜⁿ: a cost of residence at home in an area n in step t (home residence cost)
bₜ^{m}: a cost of residence in the shelter m in the step t (shelter residence cost)
Cₘ: a capacity of the shelter m
eₜ^{n→m}: a cost of evacuation from a home of the area n to the shelter m in step t (evacuation cost)
dₜ^{m→n}: a cost of return from the shelter m to a home of the area n in step t (return cost)
fₜ^{m}: a cost of management of the shelter m in step t (management cost)
   The values of the above variables are given as inputs to the linear planning problem.

That is, a value of the home residence cost of the area n in step t is substituted into aₜⁿ at the home residence cost table 122-1 (FIG. 5). The shelter residence cost of the shelter m in step t is substituted into bₜ^{m} in the shelter residence cost table 122-2 (FIG. 5). The capacity of the shelter m is substituted into Cₘ in the shelter DB 121 (FIG. 4). The evacuation cost from the area n to the shelter m in step t is substituted into eₜ^{n→m} in the evacuation cost table 123-1 (FIG. 6). The return cost from the shelter m to the area n in step t in the return cost table 123-2 (FIG. 6) is substituted into the dₜ^{m→n}. The management cost of the shelter m is substituted into fₜ^{m} in the shelter DB 121 (FIG. 4). In the embodiment, the same value is substituted for a certain shelter m in each step t. Here, when the management cost is changed for each step, the management cost of each shelter may be set in each step in the shelter DB 121.

On the other hand, the following variables are variables to be optimized (variables with which values can be obtained by solving the linear planning problem).
sₜⁿ: The number of residents staying at home in the area n in step t (the number of disaster victims)
xₜ^{n→m}: The number of residents in the area n staying in the shelter m in step t (the number of disaster victims)
vₜ^{n→m}: The number of residents who evacuate from the home of the area n to the shelter m in step t (the number of disaster victims)
zₜ^{m→n}: The number of residents returning from the shelter m to the home of the area n in step t (the number of disaster victims)
yₜ^{m}; an instruction variable for managing the shelter m in step t (1 indicates that the shelter m is managed, and 0 indicates that the shelter M is not managed.)
   The meanings of Expressions (1) to (9) are as follows.

Expression (1): an objective function of minimizing a sum of first to fifth terms.
The first term of Expression (1): an evacuation cost of a disaster victim from the home to the shelter
The second term of Expression (1): a return cost of a disaster victim returning from the shelter to the home
The third term of Expression (1): a home residence cost of the disaster victim staying at the home when the disaster victim stays at the home
The fourth term of Expression (1): a shelter residence cost of the disaster victim when the disaster victim stays in the shelter
The fifth term in Expression (1): a management cost of the shelter.

Expression (1) that is an objective function is an evaluation scale of an evacuation plan. That is, a value of Expression (1) is a value of the evaluation scale of the evacuation plan.

Expression (2): a constraint condition indicating that the number of disaster victims does not exceed a capacity of a shelter and the disaster victims cannot stay at the shelter in a closed state

Expression (3): a constraint condition indicating that an increase or decrease in the number of disaster victims staying at home matches a difference between the number of disaster victims moving to the shelter and the number of disaster victims moving from the shelter

Expression (4): a constraint condition indicating that an increase or decrease in the number of disaster victims staying in the shelter matches a difference between the number of disaster victims moving to the shelter and the number of disaster victims moving from the shelter

That is, Expressions (3) and (4) are conservation laws of the number of residents.

Expression (5): a constraint condition with s, x, V and z as non-negative integer variables (integer constraint)

Expression (6): a constraint condition (0-1 constraint) where y is an indication variable representing an opening or closing state of a shelter (where a value of y is 0 or 1)

Expression (7) indicates that an initial number of residents at the home is given.

Expression (8) indicates that the shelter is not opened initially.

Expression (9) indicates that no residents are initially in the shelter.

By solving linear planning problems of Expressions (1) to (9), the evacuation plan calculation unit 12 calculates (generates) the following evacuation plan. The evacuation plan includes a number-of-shelter resident people plan, a shelter management plan, and a number-of-moving people plan.

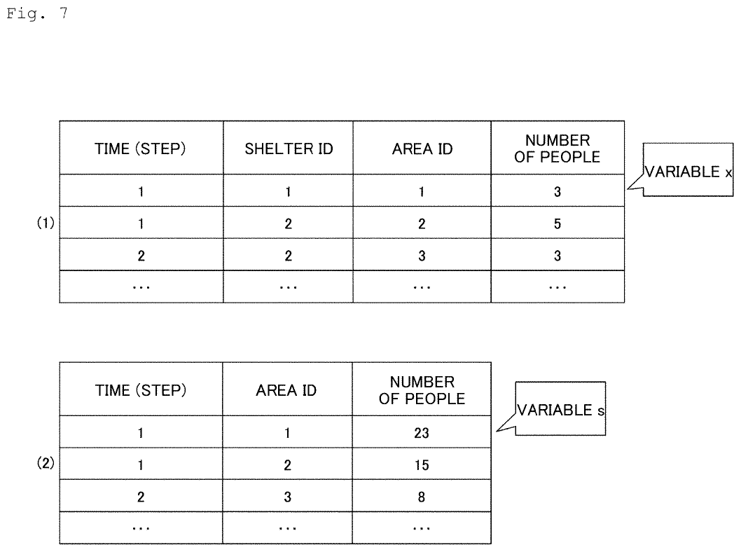

FIG. 7 is a diagram illustrating an example of the number-of-shelter resident people plan. The number-of-shelter resident people plan includes (1) a number-of-shelter resident people plan and (2) a number-of-home resident people plan.

The number-of-shelter resident people plan is data that has a value of a variable xₜ^{n→m} and indicates the number of residents (disaster victims) staying in each shelter. Specifically, the number-of-shelter resident people plan includes the number of residents in an area n where the disaster victims stay in a shelter m in each step.

The number-of-home resident people plan is a value of a variable sₜⁿ and is data chronologically indicating the number of residents (disaster victims) in each area staying at home.

Specifically, the number-of-home resident people plan includes the number of residents staying at home in the area n in each step.

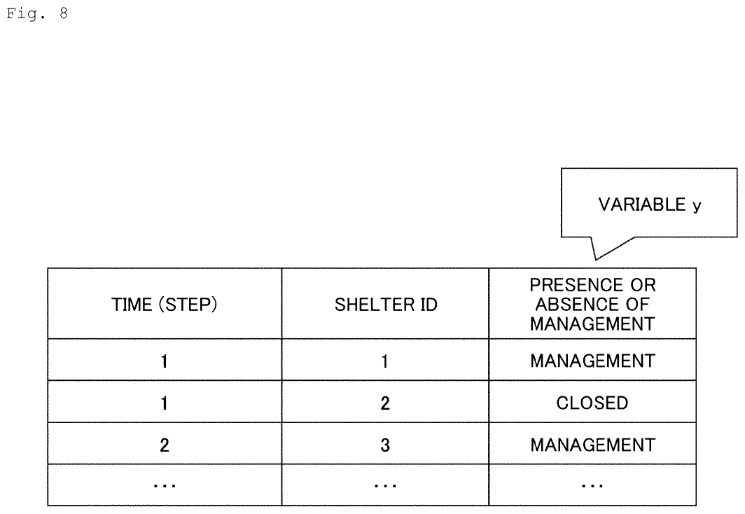

FIG. 8 is a diagram illustrating an example of a shelter management plan. The shelter management plan is a value of a variable yₜ^{m}, and is data chronologically indicating the presence or absence of management of each shelter in time series.

Specifically, the shelter management plan indicates presence or absence of management of the shelter m (whether the shelter m is closed) in each step.

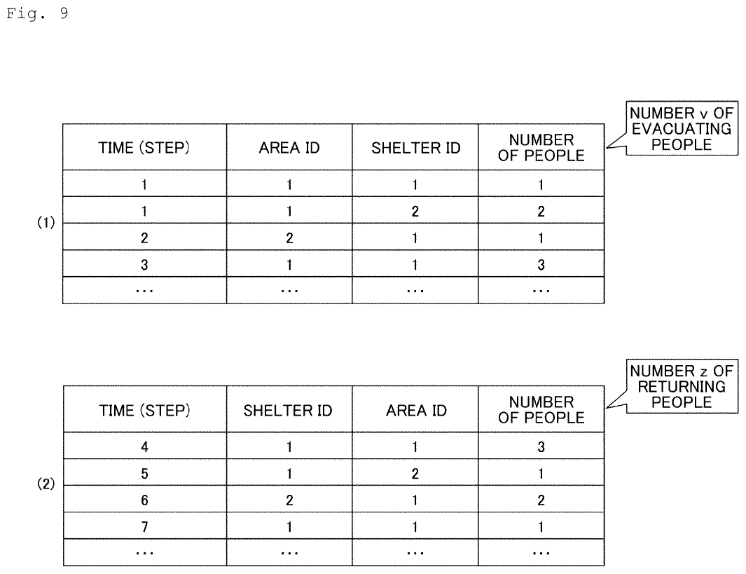

FIG. 9 is a diagram illustrating an example of a number-of-moving people plan. The number-of-moving people plan includes (1) a number-of-evacuating people plan and (2) a number-of-returning people plan.

The number-of-evacuating people plan is a value of a variable vₜ^{n→m} and is data chronologically indicating the number of disaster victims moving (evacuating) from home to each shelter.

Specifically, the number-of-evacuating people plan includes the number of residents who evacuate from the home of the area n to the shelter m in each step.

The number-of-returning people plan is a value of a variable zₜ^{m→n} and is data chronologically indicating the number of disaster victims moving (returning) from each shelter to the home.

Specifically, the number-of-returning people plan includes the number of residents returning from the shelter m to the home of the area n in each step.

After step S103, the output unit 13 outputs the evacuation plan and the value of the evaluation scale (the value of Expression (1) when the evacuation plan is calculated) (S104). An output form is not limited to the predetermined form. For example, the evacuation plan and the value of the evaluation scale may be displayed on a display device, may be stored in the auxiliary storage device 102 or the like, or may be transmitted to another device via a network.

A user can generate an evacuation plan with reference to the output evacuation plan, and can give an instruction for evacuation based on the output evacuation plan. At this time, the value of the evaluation scale indicates how much there is risk in the output evacuation plan. The larger the value is, the higher the risk is. The smaller the value is, the lower the risk is.

The evaluation scale may be calculated by substituting the evacuation plan generated manually into Expression (1). In this case, the user can evaluate the risk of the evacuation plan.

As described above, in the first embodiment, the evacuation plan is generated in consideration of presence (sₜⁿ) of the disaster victims staying at the home. Accordingly, the first embodiment can be applied to a case where the disaster victims exceeding the capacity of the shelter incur. That is, according to the first embodiment, applicability of support of evacuation can be improved.

Further, according to the first embodiment, since “presence or absence of evacuation, an evacuation destination, and a timing” are included in the models (the linear planning problems of Expressions (1) to (9)), it is possible to generate an evacuation plan with which “determining an evacuation destination”, “changing a timing of evacuation start according to the disaster victims”, and “instructing the disaster victims who do not need evacuation to stay at the home can be determined so that the disaster victims does not exceed the capacity”.

Next, a second embodiment will be described. In the second embodiment, differences from the first embodiment will be described. Points which are not mentioned particularly in the second embodiment may be similar to those of the first embodiment.

In the second embodiment, Expression (1) which is the objective function of the linear planning problem solved in step S103 is changed to the following Expression (1′).

$$[ Math . 3 ]$$

$${{\sum }_{t = 1}}^{T} [ {\sum }_{n ∈ N} {a}_{t}^{n} {s}_{t}^{n} + {\sum }_{n ∈ N} {\sum }_{m ∈ M} {b}_{t}^{m} {x}_{t}^{n \to m} + {\sum }_{m ∈ M} {f}_{t}^{m} {y}_{t}^{m} ] \qquad ( {1}^{′} )$$

That is, in the second embodiment, a movement cost (an evacuation cost and a return cost) of the disaster victims is excluded from a minimization target. Accordingly, in the second embodiment, it is not necessary to acquire data (the evacuation cost and the return cost) stored in the movement cost DB 123. Since the evacuation plan is generated in consideration of the presence (sₜⁿ) of the disaster victims staying at the home without considering the movement cost, the evacuation plan can be applied to a case where the disaster victims exceeding the capacity of the shelter incur.

Constraint conditions of Expression (1′) will be described below.

$$[ Math . 4 ]$$

$${\sum }_{n ∈ N} {x}_{t}^{n \to m} \leq {C}_{m} {y}_{t}^{m} \qquad ( 2 )$$

$${s}_{t}^{n} + {\sum }_{m ∈ M} {x}_{t}^{n \to m} = {s}_{t = 0}^{n} \qquad ( {3}^{′} )$$

$${s}_{t}^{n} , {x}_{t}^{n \to m} ∈ {Z}_{\geq 0} \qquad ( {5}^{′} )$$

$${y}_{t}^{m} ∈ \{ 0 , 1 \} \qquad ( 6 )$$

$${s}_{t}^{n} = 0 \qquad ( 7 )$$

$${y}_{t = 0}^{m} = 0 \qquad ( 8 )$$

$${x}_{t = 0}^{n \to m} = 0 \qquad ( 9 )$$

In the constraint conditions, Expressions (3) and (4) (the conservation laws of the number of residents) in the first embodiment are replaced by Expression (3′). Expression (3′) is a constraint condition indicating that a sum of the number of residents staying at the home of the area n (the number of disaster victims) in step t and the number of residents staying in the shelter m (the number of disaster victims) in the area n in step t matches the number of residents staying at the home of the area n in step t=0. In other words, Expression (3′) is the resident conservation law expressed without using the variables vₜ^{n→m} and zₜ^{m→n}. The variables vₜ^{n→m} and zₜ^{m→n} are excluded from Expression (5). The other constraint conditions may be similar to those of the first embodiment.

In the second embodiment, one or both of the shelter residence cost and the management cost may be ignored. When the shelter residence cost is ignored, 0 may be substituted into the variable bₜ^{m}. When the management cost is ignored, 0 may be substituted in fₜ^{m}. In this case, the management cost is 0, all the shelters are managed (y=1). Therefore, when the home becomes dangerous (a>0), an evacuation plan (an evacuation plan chronologically indicating the number of peoples staying at the home) for minimizing the home residence cost is calculated in a case where people evacuate until they reach the capacity Cₘ of each shelter m. As a result, the evacuation plan is generated in consideration of presence (sₜⁿ) of the disaster victims staying at home. When the chronological number of people staying at the home is known, the user can calculate the chronological number of people staying in the shelter. When the chronological number of people staying in the shelter is known, the user can specify a timing (step) of managing (opening) the shelter.

As described above, according to the second embodiment, it is also possible to improve applicability of support of evacuation.

Although the embodiments of the present invention have been described in detail above, the present invention is not limited to these particular embodiments, and various modifications and changes are possible within the scope of the gist of the present invention described in the claims.

### REFERENCE SIGNS LIST

10 Evacuation plan calculation apparatus
11 Input data setting unit
12 Evacuation plan calculation unit
13 Output unit
100 Drive device
101 Recording medium
102 Auxiliary storage device
103 Memory device
104 Processor
105 Interface device
121 Shelter DB
122 Residence cost DB
122-1 Home residence cost table
122-2 Shelter residence cost table
123 Movement cost DB
123-1 Evacuation cost table
123-2 Home-return cost table
B Bus

1. An evacuation plan calculation apparatus comprising:
a processor; and
a memory storing program instructions that cause the processor to:
calculate an evacuation plan chronologically indicating the number of residents staying at home during a predetermined period by solving a linear planning problem to minimize a home residence cost that is a cost of disaster victims staying at the home under a constraint of a capacity of a shelter during the predetermined period based on data chronologically indicating a home residence cost which is a cost per person a disaster victim of a certain disaster staying at home.

2. The evacuation plan calculation apparatus according to claim 1, wherein the program instructions cause the processor to calculate the evacuation plan by solving a linear planning problem to minimize, under the constraint, a sum of the home residence cost and a shelter residence cost that is a cost of the disaster victims staying in one of the shelters during the predetermined period based on data chronologically indicating a cost per person who stays in each shelter.

3. The evacuation plan calculation apparatus according to claim 1, wherein the program instructions cause the processor to calculate, based on a management cost of each shelter in each of time intervals where the predetermined period is divided into a plurality of time intervals, the evacuation plan by solving a linear planning problem to minimize, under the constraint, a sum of the management cost and the home residence cost during the predetermined period.

4. The evacuation plan calculation apparatus according to claim 1, wherein the program instructions cause the processor to calculate, based on data chronologically indicating a cost per person who moves from a home to each shelter, the evacuation plan by solving a linear planning problem to minimize, under the constraint, a sum of the home residence cost and an evacuation cost that is a cost of the disaster victims moving from home to a shelter during the predetermined period.

5. The evacuation plan calculation apparatus according to claim 1, wherein the program instructions cause the processor to calculate, based on data chronologically indicating a cost per person who moves from each shelter to the home, the evacuation plan by solving a linear planning problem to minimize, under the constraint, a sum of the home residence cost and a return cost that is a cost of the disaster victims moving from the shelters to the home during the predetermined period.

6. The evacuation plan calculation apparatus according to claim 1, wherein the program instructions cause the processor to calculate, based on a management cost of each shelter in each of time intervals where the predetermined period is divided into a plurality of time intervals and data chronologically indicating a cost per person who stays in each shelter, a cost per person who moves from the home to each shelter, and a cost per person who moves from each shelter to the home, the evacuation plan by solving a linear planning problem to minimize, under the constraint, a sum of a shelter residence cost that is a cost of the disaster victims staying in one of the shelters during the predetermined period, an evacuation cost that is a cost of the disaster victims moving from home to a shelter during the predetermined period, a return cost that is a cost of the disaster victims moving from the shelters to the home during the predetermined period, and the management cost and the home residence cost during the predetermined period.

7. An evacuation plan calculation method causing a computer to execute calculating an evacuation plan chronologically indicating the number of residents staying at home during a predetermined period by solving a linear planning problem to minimize a home residence cost that is a cost of disaster victims staying at the home under a constraint of a capacity of a shelter during the predetermined period based on data chronologically indicating a home residence cost which is a cost per person a disaster victim of a certain disaster staying at home.

8. A non-transitory computer-readable recording medium having stored therein a program causing a computer to execute calculating an evacuation plan chronologically indicating the number of residents staying at home during a predetermined period by solving a linear planning problem to minimize a home residence cost that is a cost of disaster victims staying at the home under a constraint of a capacity of a shelter during the predetermined period based on data chronologically indicating a home residence cost which is a cost per person a disaster victim of a certain disaster staying at home.
